(19) United States
(12) Patent Application Publication
(10) Pub. No.: US 2025/0278451 A1
(43) Pub. Date: Sep. 4, 2025

(54) SUPPORT METHOD, RECORDING MEDIUM, AND SUPPORT SYSTEM

(71) Applicant: SCREEN Holdings Co., Ltd., Kyoto (JP)

(72) Inventors: Takashi IKEUCHI, Kyoto (JP); Kazuma NAKAGAWA, Kyoto (JP); Takehiro SANO, Kyoto (JP); Manri TERADA, Kyoto (JP)

(73) Assignee: SCREEN Holdings Co., Ltd., Kyoto (JP)

(21) Appl. No.: 19/002,704

(22) Filed: Dec. 27, 2024

(30) Foreign Application Priority Data
Feb. 29, 2024 (JP) 2024-029927

(51) Int. Cl. G06F 17/11; G06F 3/04847

(52) U.S. Cl. CPC G06F 17/11; G06F 3/04847

(57) ABSTRACT

A support method includes: performing a coefficient setting process of receiving setting of a value of a risk aversion coefficient included in a heteroscedasticity acquisition function; and executing heteroscedasticity Bayesian optimization based on a first predictive distribution of an expected value of a response variable, a second predictive distribution of a variance of the response variable, a heteroscedasticity acquisition function, and an exploration range, to acquire, from within the exploration range, a recommended value of an explanatory variable that maximizes the heteroscedasticity acquisition function. The heteroscedasticity acquisition function is a function in which the larger the value of the risk aversion coefficient becomes, the higher a proportion of acquiring the recommended value from a region with a smaller variance of the response variable becomes. The coefficient setting process includes setting the value of the risk aversion coefficient based on a position of a slider operable by an operator.

### CROSS-REFERENCE TO RELATED APPLICATION

This application claims the priority benefit of Japan application serial no. 2024-029927, filed on Feb. 29, 2024. The entirety of the above-mentioned patent application is hereby incorporated by reference herein and made a part of this specification.

### BACKGROUND

### Technical Field

The disclosure relates to a support method, a recording medium, a support program, and a support system.

### Related Art

Techniques have been known to perform Bayesian optimization on a dataset in which an explanatory variable and a response variable are associated with each other, and estimate a value of the explanatory variable that optimizes (minimizes or maximizes) a value of the response variable (e.g., refer to JP 2023-174450 A). Specifically, a machine learning model is caused to learn (machine learn) the dataset, and a predictive distribution (posterior distribution) of the response variable is outputted from the machine learning model. Then, based on the predictive distribution of the response variable, an acquisition function, and an exploration range, a value (recommended value) of the explanatory variable that maximizes the acquisition function is explored from within the exploration range as a candidate for an optimal solution.

In addition, a value (observed value) of the response variable obtained by an experiment may exhibit different values for each experiment even if the experiment is performed using the same value (same experimental condition) of the explanatory variable. In other words, the value (observed value) of the response variable obtained by the experiment includes observation noise. Furthermore, a variance of the observation noise added to the value (observed value) of the response variable may differ for each value of the explanatory variable. In other words, the value (observed value) of the response variable obtained by the experiment may exhibit heteroscedasticity. In that case, it is necessary to perform Bayesian optimization considering heteroscedasticity of the value (observed value) of the response variable included in the dataset. Such Bayesian optimization is referred to as heteroscedasticity Bayesian optimization.

In the case where the value (observed value) of the response variable exhibits heteroscedasticity, a trade-off relationship may exist between an expected value (predicted value) of the response variable and a predicted variance of the response variable. For example, in the case of performing Bayesian optimization to minimize the response variable, a recommended value of the explanatory variable that minimizes the expected value (predicted value) of the response variable may increase the variance of the response variable, and a recommended value of the explanatory variable that decreases the variance of the response variable may increase the expected value (predicted value) of the response variable.

Thus, heteroscedasticity Bayesian optimization uses an acquisition function including a risk aversion coefficient for avoiding a region predicted to have a large variance to explore a candidate for the optimal solution. The larger the value of the risk aversion coefficient becomes, the more actively the region predicted to have a large variance is avoided to explore the candidate for the optimal solution. The smaller the value of the risk aversion coefficient becomes, the more passively the region predicted to have a large variance is avoided to explore the candidate for the optimal solution. The operator sets the value of the risk aversion coefficient when performing heteroscedasticity Bayesian optimization.

However, it is not likely to uniquely determine to what extent the value of the risk aversion coefficient should be increased to be capable of actively avoiding the region predicted to have a large variance. Further, scales of the response variable and the variance differ for each optimization target. Thus, a constant value cannot be used as the value of the risk aversion coefficient. Accordingly, it is not easy to control the trade-off between the expected value and the variance of the response variable.

At least one aspect of the disclosure provides a support method, a recording medium, a support program, and a support system capable of easily controlling a trade-off between an expected value and a variance of a response variable.

### SUMMARY

According to an aspect of the disclosure, a support method is a support method supporting exploration of a value of an explanatory variable that maximizes or minimizes an expected value of a response variable. The support method includes: outputting, from a first machine learning model capable of outputting a predictive distribution, a first predictive distribution which is a predictive distribution of the expected value of the response variable; outputting, from a second machine learning model capable of outputting a predictive distribution, a second predictive distribution which is a predictive distribution of a variance of the response variable; performing a coefficient setting process of receiving setting of a value of a risk aversion coefficient included in a heteroscedasticity acquisition function; and executing heteroscedasticity Bayesian optimization based on the first predictive distribution, the second predictive distribution, the heteroscedasticity acquisition function in which the value of the risk aversion coefficient is set in the coefficient setting process, and an exploration range, to acquire, from within the exploration range, a recommended value of the explanatory variable that maximizes the heteroscedasticity acquisition function. The heteroscedasticity acquisition function is a function in which the larger the value of the risk aversion coefficient becomes, the higher a proportion of acquiring the recommended value from a region with a smaller variance of the response variable becomes. The coefficient setting process includes setting the value of the risk aversion coefficient based on a position of a slider operable by an operator.

In an embodiment, in setting the value of the risk aversion coefficient, a truncated normal distribution corresponding to the position of the slider is created, and the value of the risk aversion coefficient is set based on a value randomly sampled from the truncated normal distribution.

In an embodiment, the slider is movable between a first position at which a value on a first scale indicates a value greater than 0 and a second position at which the value on the first scale indicates a value less than 1. In setting the value of the risk aversion coefficient, the closer the position of the slider is to the second position, the larger a value the risk aversion coefficient is set to.

In an embodiment, in a case of supporting exploration of a value of the explanatory variable that minimizes the expected value of the response variable, the coefficient setting process includes: displaying the slider, the first scale, a first object indicating a virtual range corresponding to a range of possible values of the response variable, a second scale indicating a virtual expected value corresponding to the expected value, and a second object indicating one of values included in the second scale; and configuring a length of the first object to be shorter and moving the second object to a position corresponding to a larger value among positions corresponding to the values included in the second scale, as the position of the slider is closer to the second position. In a case of supporting exploration of a value of the explanatory variable that maximizes the expected value of the response variable, the coefficient setting process includes: displaying the slider, the first scale, the first object, the second scale, and the second object; and configuring the length of the first object to be shorter and moving the second object to a position corresponding to a smaller value among the positions corresponding to the values included in the second scale, as the position of the slider is closer to the second position.

According to another aspect of the disclosure, a recording medium is a computer-readable medium. The recording medium records a support program specifying the above support method.

According to still another aspect of the disclosure, a support program is a computer program executable by a computer. The support program specifies the above support method.

According to still another aspect of the disclosure, a support system is a support system supporting exploration of a value of an explanatory variable that maximizes or minimizes an expected value of a response variable. The support system includes a storage part, a display part, an operation part, and a processing part. The storage part stores a first machine learning model capable of outputting a predictive distribution, a second machine learning model capable of outputting a predictive distribution, and a heteroscedasticity acquisition function. The display part displays a slider. The operation part receives an operation on the slider by an operator. The processing part outputs a first predictive distribution, which is a predictive distribution of the expected value of the response variable, from the first machine learning model, and outputs a second predictive distribution, which is a predictive distribution of a variance of the response variable, from the second machine learning model. Further, the processing part sets a value of a risk aversion coefficient included in the heteroscedasticity acquisition function based on a position of the slider. Further, the processing part executes heteroscedasticity Bayesian optimization based on the first predictive distribution, the second predictive distribution, the heteroscedasticity acquisition function in which the value of the risk aversion coefficient is set based on the position of the slider, and an exploration range, to acquire, from within the exploration range, a recommended value of the explanatory variable that maximizes the heteroscedasticity acquisition function. The heteroscedasticity acquisition function is a function in which the larger the value of the risk aversion coefficient becomes, the higher a proportion of acquiring the recommended value from a region with a smaller variance of the response variable becomes.

In an embodiment, in setting the value of the risk aversion coefficient, the processing part creates a truncated normal distribution corresponding to the position of the slider, and sets the value of the risk aversion coefficient based on a value randomly sampled from the truncated normal distribution.

In an embodiment, the display part further displays a first scale. In response to the operation on the operation part by the operator, the slider moves between a first position at which a value on the first scale indicates a value greater than 0 and a second position at which the value on the first scale indicates a value less than 1. In setting the value of the risk aversion coefficient, the processing part sets the risk aversion coefficient to a larger value as the position of the slider is closer to the second position.

In an embodiment, the display part further displays a first object indicating a virtual range corresponding to a range of possible values of the response variable, a second scale indicating a virtual expected value corresponding to the expected value, and a second object indicating one of values included in the second scale. In a case of supporting exploration of a value of the explanatory variable that minimizes the expected value of the response variable, the processing part configures a length of the first object to be shorter and moves the second object to a position corresponding to a larger value among positions corresponding to the values included in the second scale, as the position of the slider is closer to the second position. In the case of supporting exploration of a value of the explanatory variable that maximizes the expected value of the response variable, the processing part configures the length of the first object to be shorter and moves the second object to a position corresponding to a smaller value among the positions corresponding to the values included in the second scale, as the position of the slider is closer to the second position.

The support method, the recording medium, the support program, and the support system according to the embodiments of the disclosure can easily control the trade-off between the expected value and the variance of the response variable.

### BRIEF DESCRIPTION OF DRAWINGS

FIG. 1 is a block diagram showing a configuration of a support system according to Embodiment 1 of the disclosure.

FIG. 2 is a view showing an example of a predictive distribution of an expected value and a variance of a response variable.

FIG. 3 is a flowchart showing a support method according to Embodiment 1 of the disclosure.

FIG. 4 is a view showing a procedure of an experiment using the support method, a recording medium, a support program, and the support system according to Embodiment 1 of the disclosure.

FIG. 5A to FIG. 5C are views showing examples of a coefficient setting screen displayed on a display part.

FIG. 6 is a block diagram showing a configuration of a support system according to Embodiment 2 of the disclosure.

FIG. 7 is a schematic view of a substrate processing system including a support system according to Embodiment 3 of the disclosure.

FIG. 8 is a block diagram showing a configuration of the support system according to Embodiment 3 of the disclosure.

FIG. 9 is a block diagram showing a configuration of a support system according to Embodiment 4 of the disclosure.

FIG. 10A to FIG. 10C are views showing examples of a truncated normal distribution.

FIG. 11 is a flowchart showing a coefficient setting process included in a support method according to Embodiment 4 of the disclosure.

FIG. 12 is a flowchart showing an example of the coefficient setting process included in the support method according to Embodiment 4 of the disclosure.

### DESCRIPTION OF EMBODIMENTS

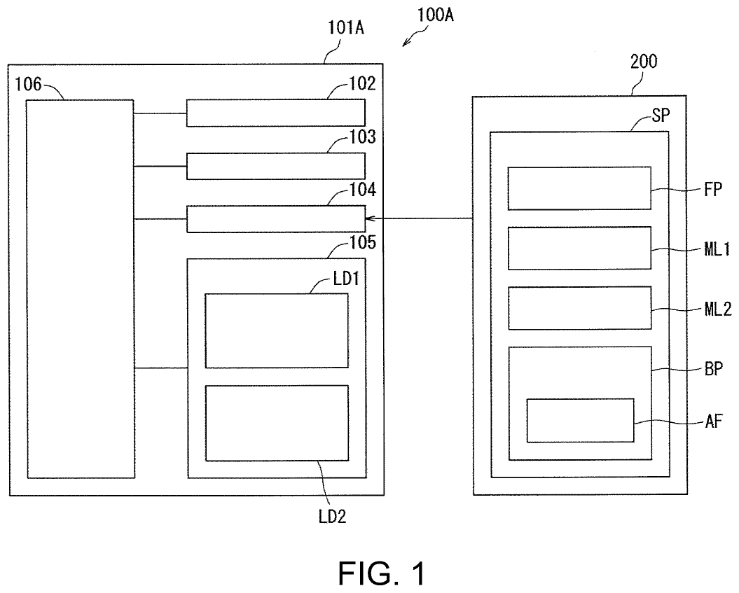

Hereinafter, embodiments related to a recording medium, a support program, and a support system of the disclosure will be described with reference to the drawings (FIG. 1 to FIG. 12). However, the disclosure is not limited to the following embodiments and may be implemented in various aspects within a range without deviating from the gist thereof. Descriptions may be omitted as appropriate wherever descriptions repeat. Further, in the figures, same or equivalent portions will be labeled with the same reference signs, and descriptions thereof will not be repeated.

### Embodiment 1

First, with reference to FIG. 1, a recording medium 200, a support program SP, and a support system 100A of this embodiment will be described. FIG. 1 is a block diagram showing a configuration of the support system 100A of this embodiment. The support system 100A is a system that supports exploration of a value (recommended value or candidate value) of an explanatory variable that optimizes (maximizes or minimizes) an expected value (predicted value) of a response variable. As shown in FIG. 1, the support system 100A of this embodiment includes a terminal device 101A. The support program SP is installed on the terminal device 101A from the recording medium 200. The terminal device 101A executes the support program SP installed from the recording medium 200 to explore the value of the explanatory variable that optimizes the expected value of the response variable. The terminal device 101A is an example of a “support device”. The terminal device 101A may be, for example, a general-purpose computer or a dedicated computer.

Specifically, the recording medium 200 is a computer-readable medium. Programs (computer programs) to be executed by a computer are non-transitorily recorded on the recording medium 200. The support program SP is recorded on the recording medium 200. In other words, the recording medium 200 stores the support program SP. The support program SP is a computer program executable by a computer.

The recording medium 200 may be, for example, a medium including a semiconductor memory such as a secure digital (SD) memory card and a universal serial bus (USB) memory, or may be a medium including a magnetic disk such as a hard disk drive. Alternatively, the recording medium 200 may be an optical disk such as a compact disk (CD), a digital versatile disk (DVD), or a Blu-ray disk, or may be a main storage device or an auxiliary storage device mounted in another computer system.

The support program SP includes a first machine learning model ML1, a second machine learning model ML2, and a heteroscedasticity Bayesian optimization program BP. In this embodiment, the support program SP further includes a preprocessing program FP.

The first machine learning model ML1 includes a model capable of outputting a predictive distribution. The first machine learning model ML1 learns (machine learns) a dataset (learning data) in which a response variable and an explanatory variable are associated with each other, and outputs a predictive distribution of an expected value of the response variable.

The second machine learning model ML2 includes a model capable of outputting a predictive distribution. The second machine learning model ML2 learns (machine learns) a dataset (learning data) in which a variance of the response variable and the explanatory variable are associated with each other, and outputs a predictive distribution of the variance of the response variable.

An algorithm of the first machine learning model ML1 is not particularly limited as long as it includes an algorithm capable of outputting a predictive distribution. The first machine learning model ML1 may include, for example, a Gaussian process regression model. Similarly, an algorithm of the second machine learning model ML2 is not particularly limited as long as it includes a model capable of outputting a predictive distribution. The second machine learning model ML2 may include, for example, a Gaussian process regression model.

The heteroscedasticity Bayesian optimization program BP includes a computer program that executes heteroscedasticity Bayesian optimization based on the predictive distribution outputted from the first machine learning model ML1, the predictive distribution outputted from the second machine learning model ML2, a heteroscedasticity acquisition function AF, and an exploration range, and outputs a value (recommended value or candidate value) of the explanatory variable that maximizes the heteroscedasticity acquisition function AF.

The preprocessing program FP includes a computer program that executes preprocessing on the dataset (learning data). In this embodiment, the dataset (learning data) after being preprocessed by the preprocessing program FP is inputted to the first machine learning model ML1. Similarly, the dataset (learning data) after being preprocessed by the preprocessing program FP is inputted to the second machine learning model ML2.

The terminal device 101A includes an operation part 102, a display part 103, an interface part 104, a storage part 105, and a processing part 106.

The operation part 102 includes a user interface device operated by an operator. The operation part 102 inputs a signal corresponding to an operation of the operator to the processing part 106. The operation part 102 may include, for example, at least one of a keyboard, a mouse, and a touch sensor. The touch sensor may be superimposed on a display surface of the display part 103. By superimposing the touch sensor on the display surface of the display part 103, a graphical user interface may be configured. For example, the operator may operate the operation part 102 to instruct installation of the support program SP. Further, the operator may operate the operation part 102 to instruct execution of the support program SP.

The display part 103 is controlled by the processing part 106 to display various screens. For example, the display part 103 may display a source code of the support program SP. For example, when the source code of the support program SP is displayed on the display part 103, the operator may operate the operation part 102 to set the dataset to be learned by the first machine learning model ML1. The display part 103 includes, for example, a display device such as a liquid crystal display device or an organic electroluminescence (EL) display device.

The interface part 104 exchanges information, data, or signals with the recording medium 200. Specifically, the interface part 104 reads the support program SP from the recording medium 200. The support program SP read from the recording medium 200 is stored in the storage part 105 by the processing part 106. As a result, the support program SP is installed on the terminal device 101A.

For example, the interface part 104 may be electrically connected to the recording medium 200 to perform input and output of information, data, or signals from and to the recording medium 200. Specifically, the interface part 104 may include a slot or a USB terminal. For example, a card-shaped information carrier, such as an SD memory card, may be inserted into the slot. For example, a USB memory may be inserted into the USB terminal, or a USB cable with one end electrically connected to a hard disk drive may have the other end inserted into the USB terminal. Alternatively, the interface part 104 may include an optical disk drive. The optical disk drive reads information (data) from a CD, a DVD, or a Blu-ray disk.

The storage part 105 has a main storage device. The main storage device includes, for example, a semiconductor memory. The storage part 105 may further have an auxiliary storage device. The auxiliary storage device includes, for example, at least one of a semiconductor memory and a hard disk drive. The storage part 105 stores various computer programs and various data. Specifically, the storage part 105 stores first learning data LD1 and second learning data LD2. Further, the storage part 105 stores the support program SP installed from the recording medium 200. In other words, the support program SP is non-transitorily recorded in the storage part 105. The storage part 105 is a recording medium that non-transitorily records the support program SP.

The first learning data LD1 is a dataset to be learned by the first machine learning model ML1. Specifically, the first learning data LD1 includes a dataset in which the response variable and the explanatory variable are associated with each other.

For example, in the case of seeking an optimal solution for at least one parameter among various parameters that specify an action of a substrate processing apparatus using the support program SP, the response variable may be a number of particles or an evaluation metric value of an etching profile. In that case, the operator repeats an experiment of processing multiple substrates with the substrate processing apparatus multiple times while changing a value (experimental condition) of a parameter which is the explanatory variable, and acquires, for each substrate, a number of particles or an evaluation metric value of the etching profile, which is the response variable. Then, a dataset (first learning data LD1) is created, in which the number of particles or the evaluation metric value of the etching profile of each substrate is associated with the corresponding value (corresponding experimental condition) of the parameter.

The second learning data LD2 is a dataset to be learned by the second machine learning model ML2. Specifically, the second learning data LD2 includes a dataset in which a variance of the response variable and the explanatory variable are associated with each other. In particular, with respect to each value of the explanatory variable, one or more corresponding values of the response variable are associated.

For example, in the case where the response variable is the number of particles or the evaluation metric value of the etching profile, even if multiple substrates are processed by the substrate processing apparatus using a specific value of the parameter, the number of particles or the evaluation metric value of the etching profile differs for each substrate. In other words, the number of particles or the evaluation metric value of the etching profile exhibits dispersion. Further, a degree of variation in the number of particles or the evaluation metric value of the etching profile differs for each value of the parameter. That is, the number of particles or the evaluation metric value of the etching profile exhibits heteroscedasticity. The operator creates a dataset (second learning data LD2) in which each value of the parameter is associated with corresponding variance of the number of particles or variance of the evaluation metric value of the etching profile.

The processing part 106 includes a processor. The processing part 106 may include, for example, a central processing unit (CPU), a graphics processing unit (GPU), a neural network processing unit (NPU), or a quantum computer. Alternatively, the processing part 106 may include a general-purpose arithmetic device or a dedicated arithmetic device. For example, the processing part 106 may include a field-programmable gate array (FPGA) or an application specific integrated circuit (ASIC).

Based on instructions from the operator inputted via the operation part 102, the processing part 106 performs various processes such as numerical calculations, information processing, and device control by executing computer programs stored in the storage part 105. For example, the processing part 106 reads the support program SP from the recording medium 200 via the interface part 104 and stores the support program SP in the storage part 105. Further, the processing part 106 executes the support program SP.

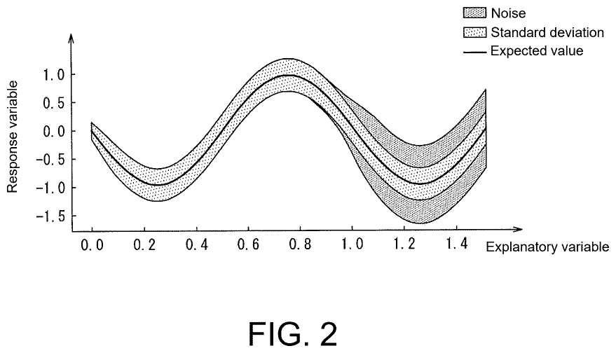

Next, referring to FIG. 2, heteroscedasticity of the response variable will be described. FIG. 2 is a view showing an example of a predictive distribution of an expected value and a variance of the response variable. In FIG. 2, the horizontal axis represents the explanatory variable. The vertical axis represents the response variable. The variance of the response variable illustrated in FIG. 2 exhibits heteroscedasticity. Specifically, the variance of the response variable includes a variance expressed by standard deviation (epistemic uncertainty) and a variance expressed by noise (aleatoric uncertainty). A magnitude of the variance expressed by standard deviation is constant with respect to each value of the explanatory variable. In contrast, noise occurs with respect to a part of values of the explanatory variable. Further, a magnitude of noise differs between one value and another value of the explanatory variable. As a result, for example, in the case of minimizing the response variable, it is likely that while a value of the explanatory variable that minimizes the expected value of the response variable increases the variance of the response variable, a value of the explanatory variable that decreases the variance of the response variable increases the expected value of the response variable.

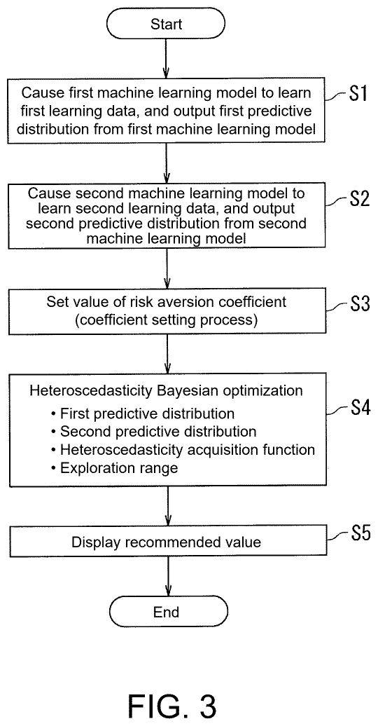

Next, referring to FIG. 1 to FIG. 3, a support method, the recording medium 200, the support program SP, and the support system 100A of this embodiment will be described. FIG. 3 is a flowchart showing a support method of this embodiment. Herein, the support method is a method for supporting exploration of a value (recommended value or candidate value) of the explanatory variable that optimizes (maximizes or minimizes) the expected value of the response variable. As shown in FIG. 3, the support method of this embodiment includes Step S1 to Step S5.

The support method of this embodiment is executed, for example, by the terminal device 101A included in the support system 100A described with reference to FIG. 1. More specifically, the support method shown in FIG. 3 is executed by the terminal device 101A executing the support program SP read from the recording medium 200. In that case, the flowchart shown in FIG. 3 corresponds to a flow of a process executed by the processing part 106 included in the terminal device 101A. In other words, FIG. 3 shows a process executed by the processing part 106 included in the support system 100A of this embodiment.

With the operator operating the operation part 102 to instruct execution of the support program SP, the process (support method) shown in FIG. 3 starts. Upon starting the process shown in FIG. 3, the processing part 106 causes the first machine learning model ML1 to learn (machine learn) the first learning data LD1, and outputs a predictive distribution of the expected value of the response variable from the first machine learning model ML1 (Step S1). The predictive distribution outputted from the first machine learning model ML1 is a predictive distribution of the expected value and the standard deviation of the response variable described with reference to FIG. 2. Hereinafter, the predictive distribution outputted from the first machine learning model ML1 may be referred to as a “first predictive distribution f”.

More specifically, the operator operates the operation part 102 to specify (set) the first learning data LD1 as the dataset to be learned by the first machine learning model ML1. Then, the operator operates the operation part 102 to instruct learning of the first learning data LD1. In response to the instruction from the operator, the processing part 106 executes the preprocessing program FP. As a result, preprocessing is executed on the first learning data LD1. Specifically, each value of the explanatory variable included in the first learning data LD1 is normalized to be within a range of 0 or more and 1 or less. Further, the response variable is standardized. The processing part 106 causes the first machine learning model ML1 to learn (machine learn) the preprocessed first learning data LD1. As a result, the first predictive distribution f is outputted from the first machine learning model ML1 and stored in the storage part 105.

Further, the processing part 106 causes the second machine learning model ML2 to learn (machine learn) the second learning data LD2, and outputs a predictive distribution of the variance of the response variable from the second machine learning model ML2 (Step S2). The predictive distribution outputted from the second machine learning model ML2 is a predictive distribution of the standard deviation and the noise of the response variable described with reference to FIG. 2. Hereinafter, the predictive distribution outputted from the second machine learning model ML2 may be referred to as a “second predictive distribution g”.

Specifically, the operator operates the operation part 102 to specify (set) the second learning data LD2 as the dataset to be learned by the second machine learning model ML2. Then, the operator operates the operation part 102 to instruct learning of the second learning data LD2. In response to the instruction from the operator, the processing part 106 executes the preprocessing program FP. As a result, preprocessing is executed on the second learning data LD2. Specifically, each value of the explanatory variable included in the second learning data LD2 is normalized to be within a range of 0 or more and 1 or less. Further, the response variable is standardized. The processing part 106 causes the second machine learning model ML2 to learn (machine learn) the preprocessed second learning data LD2. As a result, the second predictive distribution g is outputted from the second machine learning model ML2 and stored in the storage part 105.

An execution order of a first learning process (Step S1) causing the first machine learning model ML1 to learn the first learning data LD1 and a second learning process (Step S2) causing the second machine learning model ML2 to learn the second learning data LD2 may be interchanged. Alternatively, the first learning process (Step S1) and the second learning process (Step S2) may be executed in parallel. In that case, the operator operates the operation part 102 to instruct learning of the first learning data LD1 and the second learning data LD2.

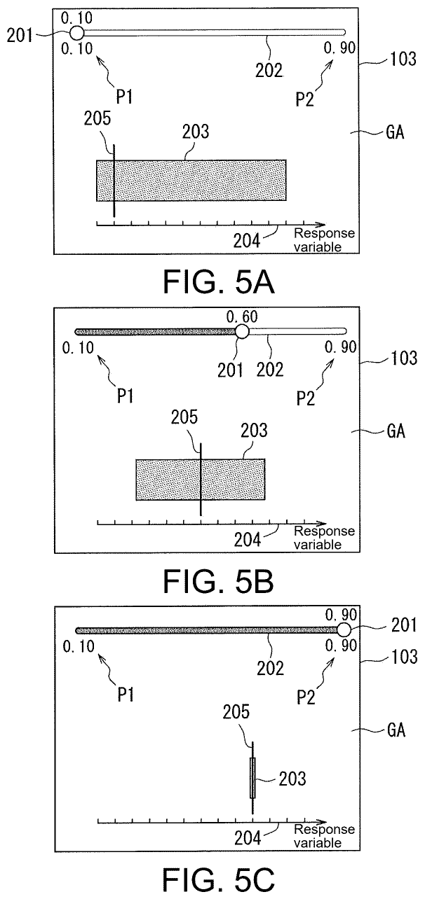

After acquiring the first predictive distribution f and the second predictive distribution g, the processing part 106 receives setting of a value of a risk aversion coefficient α included in a heteroscedasticity acquisition function AF, and sets the risk aversion coefficient α to the received value (Step S3). Specifically, as described later with reference to FIG. 5A to FIG. 5C, the processing part 106 sets the value of the risk aversion coefficient α based on a position of a slider 201. An execution order of a coefficient setting process (Step S3) is not limited to being after acquiring the first predictive distribution f and the second predictive distribution g. The value of the risk aversion coefficient α may be set any time before execution of heteroscedasticity Bayesian optimization.

Herein, the heteroscedasticity acquisition function AF and the risk aversion coefficient α will be described. The risk aversion coefficient α is a parameter that controls a trade-off between the expected value and the variance of the response variable. Specifically, the heteroscedasticity acquisition function AF is a function in which the larger a value of the risk aversion coefficient α becomes, the higher a proportion of acquiring the recommended value (or candidate value) of the explanatory variable from a region with a smaller variance of the response variable becomes. Thus, as the value of the risk aversion coefficient α increases, a region predicted to have a large variance is more actively avoided to explore the value (recommended value or candidate value) of the explanatory variable that optimizes the response variable. Further, as the value of the risk aversion coefficient α decreases, the region predicted to have a large variance is more passively avoided to explore the value (recommended value or candidate value) of the explanatory variable that optimizes the response variable.

For example, the support program SP (heteroscedasticity Bayesian optimization program BP) may include a heteroscedasticity acquisition function AF defined by Formula (1) below. Formula (1) shows a heteroscedasticity acquisition function AF defined based on an upper confidence bound (UCB) and a lower confidence bound (LCB). In the heteroscedasticity acquisition function AF of Formula (1), UCB of the first term indicates an acquisition function with respect to the first predictive distribution f. LCB of the second term indicates an acquisition function with respect to the second predictive distribution g. In Formula (1), the risk aversion coefficient α is used as a coefficient of the second term.

$${UCB}_{f} ( x ) - α {LCB}_{g} ( x ) \qquad ( 1 )$$

Alternatively, the support program SP (heteroscedasticity Bayesian optimization program BP) may include a heteroscedasticity acquisition function AF defined by Formula (2) below. Formula (2) shows a heteroscedasticity acquisition function AF defined based on an expected improvement (EI). In the heteroscedasticity acquisition function AF of Formula (2), EI of the first term indicates an acquisition function with respect to the first predictive distribution f. Formula (3) below included in the second term indicates an expected value of the second predictive distribution g. In Formula (2), the risk aversion coefficient α is used as a coefficient of the second term.

$${EI}_{f} ( x ) - α \sqrt{𝔼 [ g \vert 𝒟 ]} \qquad ( 2 )$$

$$𝔼 [ g \vert 𝒟 ] \qquad ( 3 )$$

The support program SP may include one heteroscedasticity acquisition function AF, or may include multiple types of heteroscedasticity acquisition functions AF. In the case where the support program SP includes multiple types of heteroscedasticity acquisition functions AF, before executing heteroscedasticity Bayesian optimization, the operator operates the operation part 102 to set the type of heteroscedasticity acquisition function AF to be used this time in the source code of the support program SP.

After setting the value of the risk aversion coefficient α, the processing part 106 executes the heteroscedasticity Bayesian optimization program BP (Step S4). Specifically, the processing part 106 executes heteroscedasticity Bayesian optimization based on the first predictive distribution f, the second predictive distribution g, the heteroscedasticity acquisition function AF in which the value of the risk aversion coefficient α has been set in the coefficient setting process (Step S3), and the exploration range, to acquire a value (recommended value or candidate value) of the explanatory variable that maximizes the heteroscedasticity acquisition function AF from within the exploration range. Before executing heteroscedasticity Bayesian optimization, the operator operates the operation part 102 to set the value of the exploration range in the source code of the support program SP.

Finally, the processing part 106 causes the display part 103 to display the recommended value (or candidate value) of the explanatory variable acquired by executing the heteroscedasticity Bayesian optimization (Step S5), and ends the process (support method) shown in FIG. 3. More specifically, the processing part 106 may cause the display part 103 to display a graph of the first predictive distribution f and a graph of the second predictive distribution g, along with the recommended value of the explanatory variable. Alternatively, the processing part 106 may cause the display part 103 to display respective graphs of the first predictive distribution f, the second predictive distribution g, and the heteroscedasticity acquisition function AF, along with the recommended value of the explanatory variable.

By causing the display part 103 to display the graph of the first predictive distribution f and the graph of the second predictive distribution g, the operator can more easily decide the value of the risk aversion coefficient α to be set when executing heteroscedasticity Bayesian optimization subsequently. Specifically, shapes of the respective graphs of the first predictive distribution f and the second predictive distribution g change in the process of repeating the experiment. Thus, by repeating the experiment, the operator can visually confirm how large the variance of the response variable becomes. Accordingly, the operator can check the graph of the first predictive distribution f and the graph of the second predictive distribution g, and determine whether to more actively or more passively avoid the region predicted to have a large variance when executing heteroscedasticity Bayesian optimization subsequently.

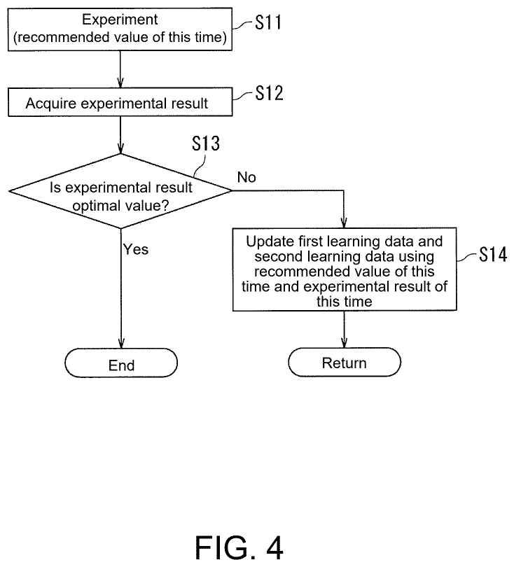

Next, referring to FIG. 4, a procedure of an experiment using the support method, the recording medium 200, the support program SP, and the support system 100A of this embodiment will be described. FIG. 4 is a view showing the procedure of the experiment using the support method, the recording medium 200, the support program SP, and the support system 100A of this embodiment.

The experiment procedure shown in FIG. 4 is started after the support method shown in FIG. 3 is executed. As shown in FIG. 4, the operator performs an experiment using the recommended value (recommended value of this time) of the explanatory variable acquired by executing the support method shown in FIG. 3 (Step S11), and acquires an experimental result (value of the response variable) (Step S12). Then, the operator determines whether the experimental result (value of the response variable) is an optimal value (maximum value or minimum value) (Step S13).

In the case of determining that the experimental result is not the optimal value (“No” in Step S13), the operator updates the first learning data LD1 and the second learning data LD2 using the value (recommended value of this time) of the explanatory variable used in the experiment of this time and the experimental result (value of the response variable) of this time (Step S14), and executes the support method described with reference to FIG. 3 again. Then, until determining that the experimental result is the optimal value, the operator repeats update of the first learning data LD1 and the second learning data LD2 (Step S14), the support method described with reference to FIG. 3, and the experiment (Step S11 and Step S12).

Upon determining that the experimental result is the optimal value (“Yes” in Step S13), the operator ends the experiment. For example, the operator may end the experiment in the case of determining that the experimental result has converged to a value within a target range.

Next, with reference to FIG. 1, FIG. 3, and FIG. 5A to FIG. 5C, the coefficient setting process (Step S3) shown in FIG. 3 will be described. FIG. 5A to FIG. 5C are views showing examples of a coefficient setting screen GA displayed on the display part 103. Specifically, FIG. 5A to FIG. 5C show the coefficient setting screen GA displayed on the display part 103 in the case of supporting exploration of a value of the explanatory variable that minimizes the expected value of the response variable.

As shown in FIG. 5A, in the coefficient setting process (Step S3), the processing part 106 causes the display part 103 to display the coefficient setting screen GA. A slider 201 is displayed on the coefficient setting screen GA. In other words, the display part 103 displays the slider 201.

The operation part 102 described with reference to FIG. 1 further receives an operation of the slider 201. The operator may operate the slider 201 via the operation part 102. Specifically, the operation part 102 receives a slide operation of the slider 201. The operator may operate the operation part 102 to slide the slider 201. In other words, the operator may operate the operation part 102 to change a position of the slider 201. The processing part 106 sets the value of the risk aversion coefficient α based on the position of the slider 201.

For example, the processing part 106 may set the value of the risk aversion coefficient α based on the position of the slider 201 and Formula (4) below. In Formula (4), β is a parameter indicating a proportion of considering the variance of the response variable with respect to the expected value of the response variable. In other words, β is a parameter indicating which of the expected value and the variance is emphasized. Hereinafter, β may be referred to as a “ratio parameter β”. Since the ratio parameter β is a parameter indicating a proportion, it indicates a value greater than 0 and less than 1 (0<β<1).

$$Risk aversion coefficient α = β / ( 1 - β ) \qquad ( 4 )$$

Specifically, the position of the slider 201 and the value of the ratio parameter β are associated with each other, and the processing part 106 changes the value of the ratio parameter β in response to a change in the position of the slider 201. The processing part 106 acquires the value of the ratio parameter β from the position of the slider 201, and sets the value of the risk aversion coefficient α based on the acquired value of the ratio parameter β and Formula (4). More specifically, a confirm button (soft button) (not shown) is further displayed on the coefficient setting screen GA. With the operator operating the operation part 102 to press the confirm button, the processing part 106 acquires the value of the ratio parameter β from the position of the slider 201 of the time the confirm button is pressed.

More specifically, the slider 201 is slidable (movable) between a first position P1 and a second position P2. The closer the position of the slider 201 is to the second position P2, the larger the value of the ratio parameter β becomes. As a result, the value of the risk aversion coefficient α becomes larger. Thus, the closer the slider 201 is moved to the second position P2, the more actively a region predicted to have a large variance is avoided to explore the value of the explanatory variable that optimizes the response variable. In contrast, the closer the slider 201 is moved to the first position P1, the more passively the region predicted to have a large variance is avoided to explore the value of the explanatory variable that optimizes the response variable.

In this embodiment, the display part 103 further displays a first scale 202, a first indicator 203, a second scale 204, and a second indicator 205. Specifically, the first scale 202, the first indicator 203, the second scale 204, and the second indicator 205 are further displayed on the coefficient setting screen GA.

The slider 201 moves on the first scale 202. Each value included in the first scale 202 indicates the value of the ratio parameter β. Thus, the position of the slider 201 on the first scale 202 indicates the value of the ratio parameter β. As described earlier, the ratio parameter β indicates a value greater than 0 and less than 1 (0<β<1). Thus, the first scale 202 shows each value in a range greater than 0 and less than 1.

In this embodiment, the slider 201 moves in increments of 0.1. For example, the slider 201 may be movable from a position indicating a value of 0.1 on the first scale 202 to a position indicating a value of 0.9 on the first scale 202. In that case, the first position P1 indicates a position at which the value on the first scale 202 is 0.1. The second position P2 indicates a position at which the value on the first scale 202 is 0.9.

The first indicator 203 shows a virtual range corresponding to a range of possible values of the response variable. In other words, the first indicator 203 shows an image of the range of possible values of the response variable. The first indicator 203 is an example of a “first object”.

The second scale 204 shows a virtual expected value corresponding to the expected value of the response variable. The second indicator 205 indicates one of the values included in the second scale 204. In other words, the second indicator 205 indicates a virtual expected value of the response variable. The second indicator 205 is an example of a “second object”. The second scale 204 may also show the expected value of the response variable.

FIG. 5A shows a coefficient setting screen GA when the slider 201 is located at a position indicating a value of 0.1 on the first scale 202. FIG. 5B shows a coefficient setting screen GA when the slider 201 is located at a position indicating a value of 0.6 on the first scale 202. FIG. 5C shows a coefficient setting screen GA when the slider 201 is located at a position indicating a value of 0.9 on the first scale 202.

As shown in FIG. 5A to FIG. 5C, the processing part 106 causes the coefficient setting screen GA (display part 103) to display the value at which the slider 201 is located among the values included in the first scale 202. In other words, the processing part 106 causes the display part 103 to display the value of the ratio parameter β. As a result, the operator can visually recognize (confirm) the value of the ratio parameter β. Thus, it is possible to support determination on whether to more actively or more passively avoid the region predicted to have a large variance. Accordingly, the operator can more easily control the trade-off between the expected value and the variance of the response variable.

Further, as shown in FIG. 5A to FIG. 5C, the processing part 106 configures a length of the first indicator 203 to be shorter as the position of the slider 201 is closer to the second position P2 (β=0.9). Further, the processing part 106 configures the length of the first indicator 203 to be longer as the position of the slider 201 is closer to the first position P1 (β=0.1).

Since the length of the first indicator 203 corresponds to the range of possible values of the response variable, a shorter length of the first indicator 203 indicates that the range of possible values of the response variable becomes narrower. In other words, it indicates that the region predicted to have a large variance is more actively avoided. A longer length of the first indicator 203 indicates that the range of possible values of the response variable becomes larger. In other words, it indicates that the region predicted to have a large variance is more passively avoided. Thus, based on the length of the first indicator 203, the operator can intuitively determine whether the value of the risk aversion coefficient α is set to a value that more actively avoids the region predicted to have a large variance, or is set to a value that more passively avoids this region. Accordingly, the operator can more easily control the trade-off between the expected value and the variance of the response variable.

Furthermore, as shown in FIG. 5A to FIG. 5C, the processing part 106 moves the second indicator 205 to a position corresponding to a larger value (larger expected value) among the values included in the second scale 204 as the position of the slider 201 is closer to the second position P2 (β=0.9). Further, the processing part 106 moves the second indicator 205 to a position corresponding to a smaller value (smaller expected value) among the values included in the second scale 204 as the position of the slider 201 is closer to the first position P1 (β=0.1).

Thus, in the case of minimizing the response variable, the operator can visually recognize that as the position of the slider 201 approaches the second position P2 (β=0.9), the region predicted to have a large variance is more actively avoided and the expected value of the response variable increases; as the position of the slider 201 approaches the first position P1 (β=0.1), the region predicted to have a large variance is more passively avoided and the expected value of the response variable decreases. In other words, the operator can visually recognize a proportion of considering the variance of the response variable with respect to the expected value of the response variable. Thus, the operator can more easily control the trade-off between the expected value and the variance of the response variable.

The coefficient setting screen GA displayed on the display part 103 in the case of supporting exploration of the value of the explanatory variable that maximizes the expected value of the response variable differs only in the position of the second indicator 205 compared to the case of minimizing the response variable. Specifically, in the case of maximizing the response variable, the processing part 106 moves the second indicator 205 to a position corresponding to a smaller value (smaller expected value) among the values included in the second scale 204 as the position of the slider 201 is closer to the second position P2 (β=0.9). Further, the processing part 106 moves the second indicator 205 to a position corresponding to a larger value (larger expected value) among the values included in the second scale 204 as the position of the slider 201 is closer to the first position P1 (β=0.1).

Embodiment 1 of the disclosure has been described above with reference to FIG. 1 to FIG. 4 and FIG. 5A to FIG. 5C. According to Embodiment 1, the operator can operate the slider 201 to set the value of the risk aversion coefficient α. Thus, the operator can operate the slider 201 to more easily control the trade-off between the expected value and the variance of the response variable.

Furthermore, according to Embodiment 1, since the value of the ratio parameter β corresponding to the position of the slider 201 is displayed, the operator can operate the slider 201 to more easily control the trade-off between the expected value and the variance of the response variable.

Further, according to Embodiment 1, the ratio parameter β is a parameter indicating a proportion and shows a value greater than 0 and less than 1 (0<β<1). Thus, the operator can easily recognize the magnitude of the proportion of considering the variance of the response variable with respect to the expected value of the response variable. As a result, the operator can operate the slider 201 to more easily control the trade-off between the expected value and the variance of the response variable.

Further, according to Embodiment 1, the operator can visually recognize the relationship (trade-off relationship) between the range of possible values of the response variable and the expected value of the response variable based on the length of the first indicator 203 and the position of the second indicator 205. Thus, the operator can operate the slider 201 to more easily control the trade-off between the expected value and the variance of the response variable.

In the embodiment described with reference to FIG. 1 to FIG. 4 and FIG. 5A to FIG. 5C, the support system 100A (terminal device 101A) acquires the support program SP from the recording medium 200, but the support system 100A (terminal device 101A) may also acquire the support program SP from another computer system. For example, the terminal device 101A may be communicably connected to another computer system via a cable and acquire the support program SP from the another computer system. Alternatively, the terminal device 101A may be communicably connected to another computer system via a network such as the Internet and acquire the support program SP from the another computer system. The another computer system may be a general-purpose computer or a dedicated computer. The another computer system may also be a server.

Further, in the embodiment described with reference to FIG. 1 to FIG. 4 and FIG. 5A to FIG. 5C, the support program SP is installed on the terminal device 101A, but it is also possible that the support program SP is not installed on the terminal device 101A. The terminal device 101A may execute the support program SP stored in the recording medium 200.

### Embodiment 2

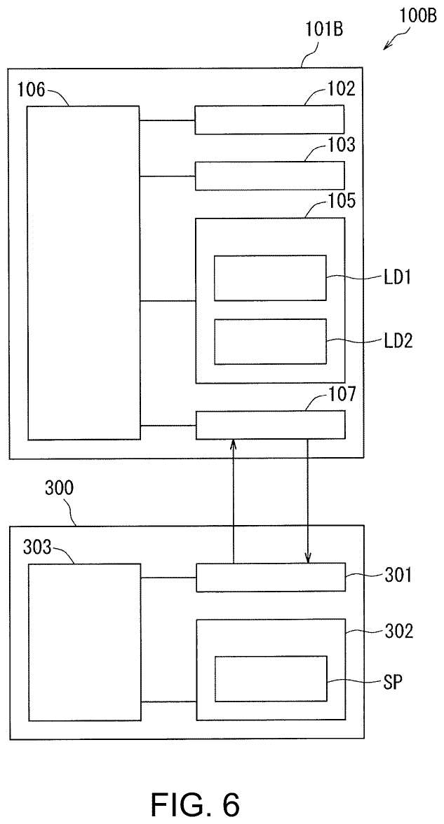

Next, Embodiment 2 of the disclosure will be described with reference to FIG. 3, FIG. 5A to FIG. 5C, and FIG. 6. However, only aspects that differ from Embodiment 1 will be described, and descriptions of aspects that are the same as in Embodiment 1 will be omitted. Embodiment 2 differs from Embodiment 1 in that a server 300 outputs a recommended value (candidate value) of the explanatory variable based on the support program SP.

FIG. 6 is a block diagram showing a configuration of a support system 100B of Embodiment 2. As shown in FIG. 6, the support system 100B includes a terminal device 101B and a server 300.

In Embodiment 2, the terminal device 101B includes an operation part 102, a display part 103, a storage part 105, a communication part 107, and a processing part 106.

The communication part 107 is connected to a network and executes communication with the server 300. The network includes, for example, the Internet, a local area network (LAN), a public telephone network, and a short-range wireless network. The communication part 107 includes a communication device. The communication part 107 is, for example, a network interface controller.

The communication part 107 is controlled by the processing part 106 to exchange information, data, or signals with the server 300. For example, the communication part 107 transmits first learning data LD1, second learning data LD2, and information indicating a value of the exploration range to the server 300.

The server 300 includes a communication part 301, a storage part 302, and a processing part 303.

The communication part 301 is connected to a network and executes communication with the terminal device 101B. The communication part 301 includes a communication device. The communication part 301 is, for example, a network interface controller. The communication part 301 is controlled by the processing part 303 to exchange information, data, or signals with the terminal device 101B. For example, the communication part 301 receives the first learning data LD1, the second learning data LD2, and the information indicating the value of the exploration range from the terminal device 101B.

The storage part 302 has a main storage device and an auxiliary storage device. The main storage device includes, for example, a semiconductor memory. The auxiliary storage device includes, for example, a hard disk drive. The storage part 302 stores the support program SP. Further, the storage part 302 stores the first learning data LD1, the second learning data LD2, and the information indicating the value of the exploration range received from the terminal device 1B.

The processing part 303 includes a processor. The processing part 303 may include, for example, a CPU, a GPU, an NPU, or a quantum computer. Alternatively, the processing part 303 may include a general-purpose arithmetic device or a dedicated arithmetic device. For example, the processing part 303 may include an FPGA or an ASIC. The processing part 303 executes the support program SP based on an instruction from the terminal device 101B.

Next, referring to FIG. 6 and FIG. 3, a support method, the support program SP, and the support system 100B of Embodiment 2 will be described. The processing part 303 starts a process shown in FIG. 3 based on an instruction from the terminal device 101B.

Upon starting the process shown in FIG. 3, the processing part 303 causes the first machine learning model ML1 to learn (machine learn) the first learning data LD1 received from the terminal device 101B, and outputs a predictive distribution (first predictive distribution f) of the expected value of the response variable from the first machine learning model ML1 (Step S1). Further, the processing part 303 causes the second machine learning model ML2 to learn (machine learn) the second learning data LD2 received from the terminal device 101B, and outputs a predictive distribution (second predictive distribution g) of the variance of the response variable from the second machine learning model ML2 (Step S2).

After acquiring the first predictive distribution f and the second predictive distribution g, the processing part 303 receives setting of a value of the risk aversion coefficient α included in the heteroscedasticity acquisition function AF, and sets the risk aversion coefficient α to the received value (Step S3).

Specifically, the processing part 303 transmits the coefficient setting screen GA described with reference to FIG. 5A to FIG. 5C to the terminal device 101B, and causes the display part 103 of the terminal device 101B to display the coefficient setting screen GA.

As described with reference to FIG. 5A to FIG. 5C, the operator slides the slider 201 and presses the confirm button (not shown). As a result, the processing part 303 acquires a value of the ratio parameter β, and sets the value of the risk aversion coefficient α based on the acquired value of the ratio parameter β and Formula (4) above.

Specifically, operation information indicating an operation content of the operation part 102 by the operator is transmitted from the terminal device 101B to the server 300. For example, in the case where the operation content indicates an operation (slide operation) of changing the position of the slider 201, based on the operation information received from the terminal device 101B, the processing part 303 transmits a coefficient setting screen GA with the changed position of the slider 201 to the terminal device 101B, and causes the coefficient setting screen GA displayed on the display part 103 to transition. Further, in the case where the operation content indicates an operation of pressing the confirm button (not shown) on the coefficient setting screen GA, based on the operation information received from the terminal device 101B, the processing part 303 acquires the value of the ratio parameter β from the position of the slider 201 of the time the confirm button is pressed.

After setting the value of the risk aversion coefficient α, the processing part 303 executes the heteroscedasticity Bayesian optimization program BP to acquire a value (recommended value or candidate value) of the explanatory variable that maximizes the heteroscedasticity acquisition function AF (Step S4). Then, the processing part 303 transmits information indicating the recommended value (or candidate value) of the explanatory variable to the terminal device 101B and causes the display part 103 to display the recommended value of the explanatory variable (Step S5). As a result, the process (support method) shown in FIG. 3 is ended.

More specifically, along with the information indicating the recommended value of the explanatory variable, the processing part 303 may transmit information indicating a graph of the first predictive distribution f and information indicating a graph of the second predictive distribution g to the terminal device 101B to cause the display part 103 to further display the graph of the first predictive distribution f and the graph of the second predictive distribution g. Alternatively, along with the information indicating the recommended value of the explanatory variable, the processing part 303 may transmit information indicating respective graphs of the first predictive distribution f, the second predictive distribution g, and the heteroscedasticity acquisition function AF to the terminal device 101B to cause the display part 103 to further display the respective graphs of the first predictive distribution f, the second predictive distribution g, and the heteroscedasticity acquisition function AF.

Embodiment 2 of the disclosure has been described above with reference to FIG. 3, FIG. 5A to FIG. 5C, and FIG. 6. According to Embodiment 2, similar to Embodiment 1, the operator can operate the slider 201 to more easily control the trade-off between the expected value and the variance of the response variable.

### Embodiment 3

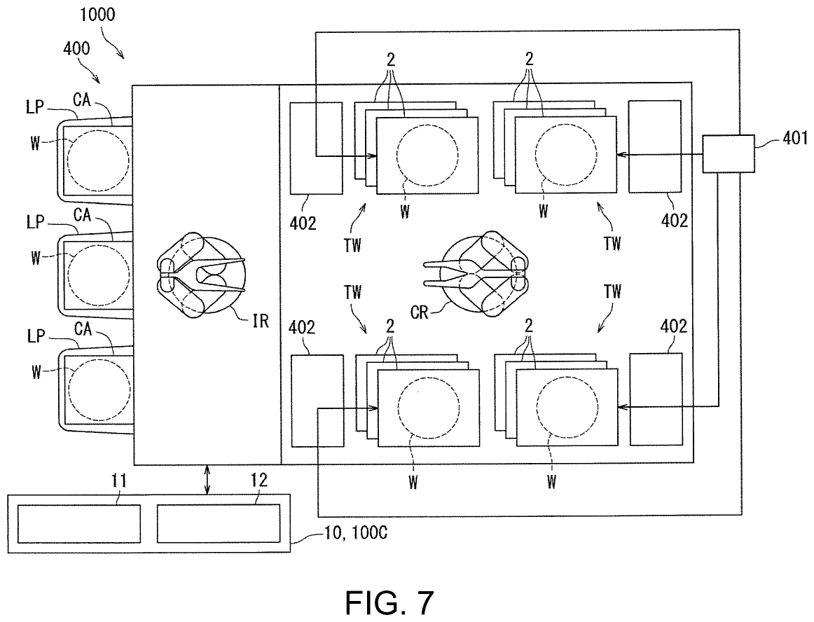

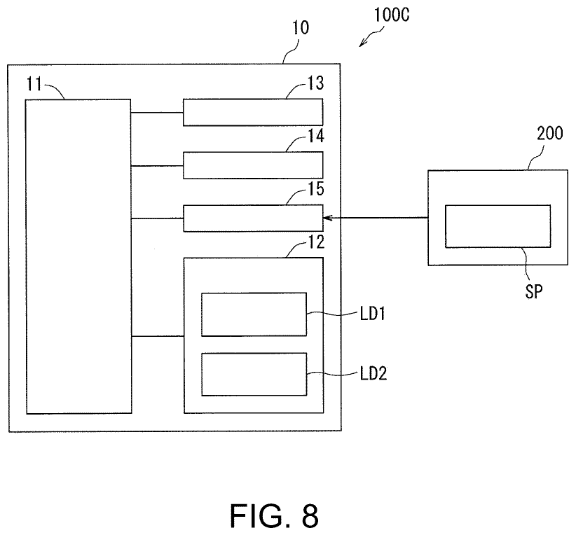

Next, Embodiment 3 of the disclosure will be described with reference to FIG. 7 and FIG. 8. However, only aspects that differ from Embodiments 1 and 2 will be described, and descriptions of aspects that are the same as in Embodiments 1 and 2 will be omitted. Embodiment 3 differs from Embodiments 1 and 2 in that a control device 10 included in a substrate processing system 1000 also serves as a support system 100C.

FIG. 7 is a schematic view of the substrate processing system 1000 including the support system 100C of this embodiment. Specifically, FIG. 7 is a schematic plan view of a substrate processing apparatus 400 included in the substrate processing system 1000.

As shown in FIG. 7, the substrate processing system 1000 includes a substrate processing apparatus 400 and a control device 10. The substrate processing apparatus 400 processes a substrate W. The control device 10 controls the substrate processing apparatus 400. In this embodiment, the substrate W is a disk-shaped semiconductor wafer. Further, the substrate processing apparatus 400 is a single-type apparatus that processes one substrate W at a time.

Specifically, the substrate processing apparatus 400 includes multiple substrate processing parts 2, a fluid cabinet 401, multiple fluid boxes 402, multiple load ports LP, an indexer robot IR, and a center robot CR.

A cassette CA is placed at each of the load ports LP. The cassette CA accommodates multiple substrates W stacked. The cassette CA is, for example, a front opening unified pod (FOUP), a standard mechanical interface (SMIF) pod, or an open cassette (OC).

The indexer robot IR transports the substrate W between the cassette CA and the center robot CR. The center robot CR transports the substrate W between the indexer robot IR and the multiple substrate processing parts 2. The apparatus may also be configured such that a placement stage (pass) for temporarily placing the substrate W is provided between the indexer robot IR and the center robot CR to indirectly transfer the substrate W between the indexer robot IR and the center robot CR via the placement stage.

The multiple substrate processing parts 2 form multiple towers TW (four towers TW in FIG. 7). The multiple towers TW are disposed to surround the center robot CR in a plan view. Each tower TW includes multiple substrate processing parts 2 (three substrate processing parts 2 in FIG. 7) stacked in an up-down direction.

The fluid cabinet 401 accommodates a fluid. Specifically, the fluid cabinet 401 accommodates a processing solution. Alternatively, the fluid cabinet 401 may accommodate a processing solution and a gas.

The processing solution is not particularly limited as long as it is a liquid that contacts the substrate W. The processing solution may include, for example, dilute hydrofluoric acid (DHF), hydrofluoric acid (HF), nitrohydrofluoric acid (a mixed solution of hydrofluoric acid and nitric acid (HNO₃)), buffered hydrofluoric acid (BHF), ammonium fluoride, HFEG (a mixed solution of hydrofluoric acid and ethylene glycol), phosphoric acid (H₃PO₄), sulfuric acid, acetic acid, nitric acid, hydrochloric acid, ammonia water, hydrogen peroxide water, organic acid (e.g., citric acid, oxalic acid), organic alkali (e.g., tetramethylammonium hydroxide (TMAH)), sulfuric acid-hydrogen peroxide mixture (SPM), ammonia-hydrogen peroxide mixture (SC1), hydrochloric acid-hydrogen peroxide mixture (SC2), isopropyl alcohol (IPA), a surfactant, a corrosion inhibitor, pure water (e.g., deionized water), carbonated water, electrolyzed ionic water, hydrogen water, ozone water, or hydrochloric acid water with a diluted concentration (e.g., about 0.001 wt % to about 0.01 wt %). The gas may include, for example, an inert gas. The inert gas is, for example, nitrogen gas.

Each fluid box 402 corresponds to one of the multiple towers TW. The fluid in the fluid cabinet 401 is supplied to all substrate processing parts 2 included in the corresponding tower TW via one of the fluid boxes 402.

Each of the substrate processing parts 2 processes one substrate W at a time. Specifically, each of the substrate processing parts 2 supplies the processing solution to the substrate W to process the substrate W. For example, each of the substrate processing parts 2 performs a cleaning process or an etching process on the substrate W.

The control device 10 controls an action of each part of the substrate processing apparatus 400. For example, the control device 10 controls the substrate processing part 2, the fluid cabinet 401, the fluid box 402, the load port LP, the indexer robot IR, and the center robot CR. The control device 10 includes a control part 11 and a storage part 12.

The control part 11 controls the action of each part of the substrate processing apparatus 400 based on various information stored in the storage part 12. The control part 11 includes a processor. The control part 11 may include, for example, a CPU, a GPU, an NPU, or a quantum computer. Alternatively, the control part 11 may include a general-purpose arithmetic device or a dedicated arithmetic device. For example, the control part 11 may include an FPGA or an ASIC.

The storage part 12 stores various information for controlling the action of the substrate processing apparatus 400. For example, the storage part 12 stores various data and various computer programs. The various data includes recipe data. The recipe data indicates recipes that specify processing contents, processing conditions, and processing procedures of the substrate W. In the recipes, various setting values (recipe parameter values) are set as processing conditions.

The storage part 12 has a main storage device. The main storage device includes, for example, a semiconductor memory. The storage part 12 may further have an auxiliary storage device. The auxiliary storage device includes, for example, at least one of a semiconductor memory and a hard disk drive.

FIG. 8 is a block diagram showing a configuration of the support system 100C of this embodiment. Specifically, FIG. 8 is a block diagram showing the configuration of the control device 10.

As shown in FIG. 7 and FIG. 8, the control device 10 also serves as the support system 100C. Specifically, as shown in FIG. 8, the support program SP is installed in the control device 10 from the recording medium 200. Similar to the terminal device 101A described with reference to FIG. 1 to FIG. 4 and FIG. 5A to FIG. 5C, the control device 10 executes the support program SP installed from the recording medium 200 to explore a value (recommended value or candidate value) of the explanatory variable that optimizes the expected value of the response variable. The control device 10 is an example of a “support device”.

Specifically, as shown in FIG. 8, the control device 10 further includes an operation part 13, a display part 14, and an interface part 15. Configurations of the operation part 13, the display part 14, and the interface part 15 are similar to those of the operation part 102, the display part 103, and the interface part 104 described with reference to FIG. 1, so descriptions thereof will be omitted.

Similar to the storage part 105 described with reference to FIG. 1, the storage part 12 stores the first learning data LD1, the second learning data LD2, and the support program SP read from the recording medium 200 by the interface part 15. In the substrate processing system 1000, the explanatory variable may include, for example, at least one of various setting values (recipe parameter values) specified by the recipes and various setting values (apparatus parameter values) set for the substrate processing apparatus 400. Further, in the case where the substrate processing part 2 executes a cleaning process, the response variable may be, for example, a number of particles. In the case where the substrate processing part 2 executes an etching process, the response variable may be, for example, an evaluation metric value of the etching profile.

Similar to the processing part 106 described with reference to FIG. 1 to FIG. 4 and FIG. 5A to FIG. 5C, the control part 11 executes the support program SP to output a value (recommended value or candidate value) of the explanatory variable that optimizes the expected value of the response variable.

Embodiment 3 of the disclosure has been described above with reference to FIG. 7 and FIG. 8. According to Embodiment 3, similar to Embodiments 1 and 2, the operator can operate the slider 201 to more easily control the trade-off between the expected value and the variance of the response variable.

In Embodiment 3, the substrate processing apparatus 400 performs a cleaning process or an etching process on the substrate W, but the substrate processing apparatus 400 is not particularly limited as long as it is an apparatus that processes a substrate. For example, the substrate processing apparatus 400 may also be a coating apparatus, a developing apparatus, an exposure apparatus, a baking apparatus, or a film formation apparatus.

Further, in Embodiment 3, the substrate processing apparatus 400 is a single-type apparatus, but the substrate processing apparatus 400 may also be a batch-type apparatus.

Further, in Embodiment 3, the substrate processing apparatus 400 processes a disk-shaped semiconductor wafer, but the targeted substrate of substrate processing is not limited to a semiconductor wafer. The targeted substrate of substrate processing may also be a glass substrate for a photomask, a glass substrate for liquid crystal display, a glass substrate for plasma display, a substrate for field emission display (FED), a substrate for an optical disk, a substrate for a magnetic disk, or a substrate for a magneto-optical disk. Further, a shape of the targeted substrate of substrate processing is not limited to a disk-shape.

### Embodiment 4

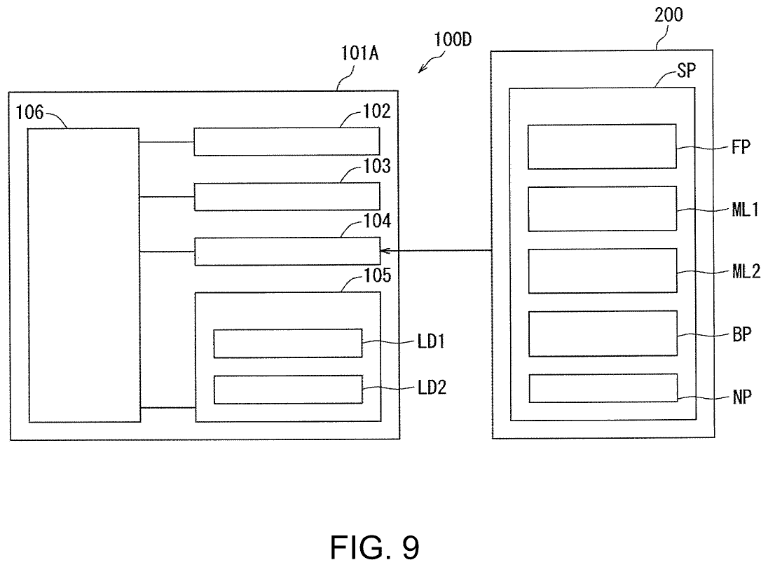

Next, Embodiment 4 of the disclosure will be described with reference to FIG. 9 to FIG. 12. However, only aspects that differ from Embodiments 1 to 3 will be described, and descriptions of aspects that are the same as in Embodiments 1 to 3 will be omitted. In Embodiment 4, Step S3 (coefficient setting process) shown in FIG. 3 differs from Embodiments 1 to 3. In other words, Embodiment 4 differs from Embodiments 1 to 3 in the method of setting the risk aversion coefficient α.

FIG. 9 is a block diagram showing a configuration of a support system 100D of this embodiment. As shown in FIG. 9, the support system 100D includes a terminal device 101A, similar to the support system 100A described with reference to FIG. 1 to FIG. 4 and FIG. 5A to FIG. 5C. The support program SP read from the recording medium 200 is stored in the storage part 105 of the terminal device 101A. The support system 100D differs from the support system 100A in that the support program SP further includes a truncated normal distribution sampling program NP.

The truncated normal distribution sampling program NP includes each expected value corresponding to each value of the ratio parameter β capable of being set by the operator operating the slider 201 (refer to FIG. 5A to FIG. 5C). In other words, the truncated normal distribution sampling program NP includes each expected value corresponding to each position to which the slider 201 is movable. Further, the truncated normal distribution sampling program NP includes a predetermined value of standard deviation.

When setting the value of the risk aversion coefficient α, the processing part 106 executes the truncated normal distribution sampling program NP. Specifically, when setting the value of the risk aversion coefficient α, the processing part 106 acquires the value of the ratio parameter β set by the operator operating the slider 201. Then, the processing part 106 creates a truncated normal distribution ND based on the expected value corresponding to the acquired value of the ratio parameter β and the predetermined value of standard deviation. In other words, the processing part 106 creates a truncated normal distribution ND corresponding to the position of the slider 201.

For example, in the case where the slider 201 moves in increments of 0.1 within a range of 0.1 or more and 0.9 or less, the values of the ratio parameter β capable of being set by the operator operating the slider 201 include nine values: “0.1”, “0.2”, . . . , “0.8”, and “0.9”. Thus, the truncated normal distribution sampling program NP includes nine values “0.1”, “0.2”, . . . , “0.8”, and “0.9” as expected values used for creating the truncated normal distribution ND.

Further, the truncated normal distribution ND indicates a probability distribution with a finite domain of a random variable. In this embodiment, the domain of the random variable is set to the range in which the slider 201 is movable. For example, in the case where the slider 201 moves within a range of 0.1 or more and 0.9 or less, the domain of the random variable is set to the range of 0.1 or more and 0.9 or less.

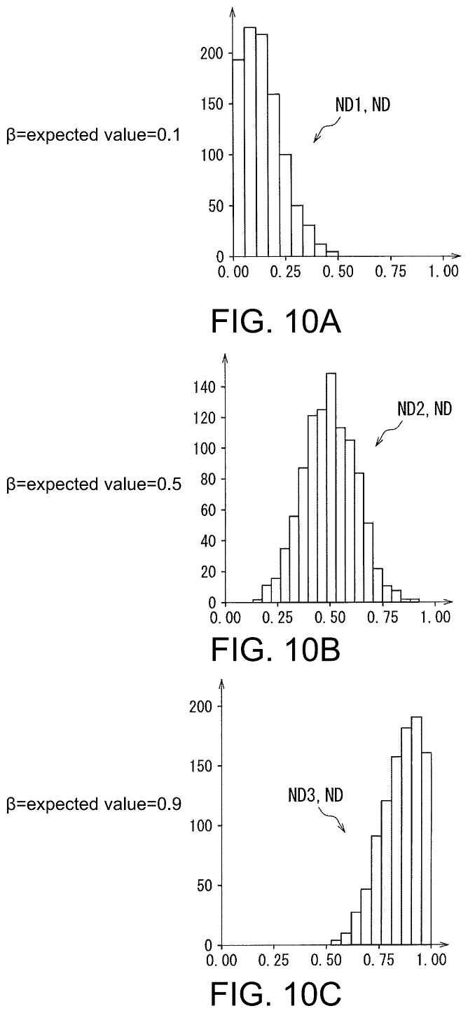

FIG. 10A to FIG. 10C are views showing examples of the truncated normal distribution ND created by the processing part 106 executing the truncated normal distribution sampling program NP.

Specifically, FIG. 10A shows a truncated normal distribution ND1 with an expected value of “0.1”. FIG. 10B shows a truncated normal distribution ND2 with an expected value of “0.5”. FIG. 10C shows a truncated normal distribution ND3 with an expected value of “0.9”. As shown in FIG. 10A to FIG. 10C, truncated normal distributions ND with different shapes are created for each expected value. For example, in the case where the value of the ratio parameter β set by the operator operating the slider 201 is “0.1”, the processing part 106 creates the truncated normal distribution ND1 shown in FIG. 10A.

The truncated normal distribution sampling program NP may also include predetermined values of standard deviation for each value of the ratio parameter β capable of being set by the operator operating the slider 201.

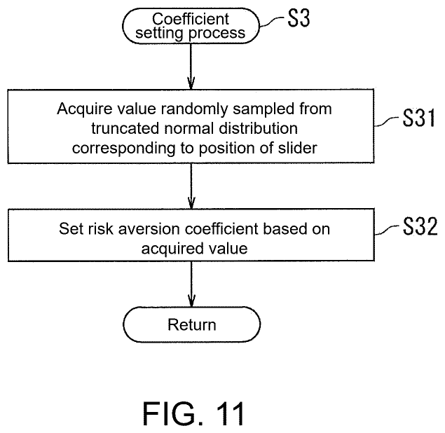

FIG. 11 is a flowchart showing a coefficient setting process (Step S3 in FIG. 3) included in a support method of Embodiment 4. In other words, FIG. 11 shows a flow of a process executed by the processing part 106 included in the terminal device 101A.

Upon starting the coefficient setting process, the processing part 106 causes the display part 103 to display the coefficient setting screen GA as described with reference to FIG. 5A to FIG. 5C. Then, the processing part 106 creates a truncated normal distribution ND corresponding to the position of the slider 201 of the time the confirm button (not shown) is pressed, and acquires a value randomly sampled from the created truncated normal distribution ND (Step S31). Then, the processing part 106 sets the risk aversion coefficient α based on the value acquired from the truncated normal distribution ND (Step S32). As a result, the process shown in FIG. 11 is ended. Specifically, the processing part 106 sets the value acquired from the truncated normal distribution ND as the value of the ratio parameter β in Formula (4) above. As a result, the value of the risk aversion coefficient α is set based on Formula (4) above.

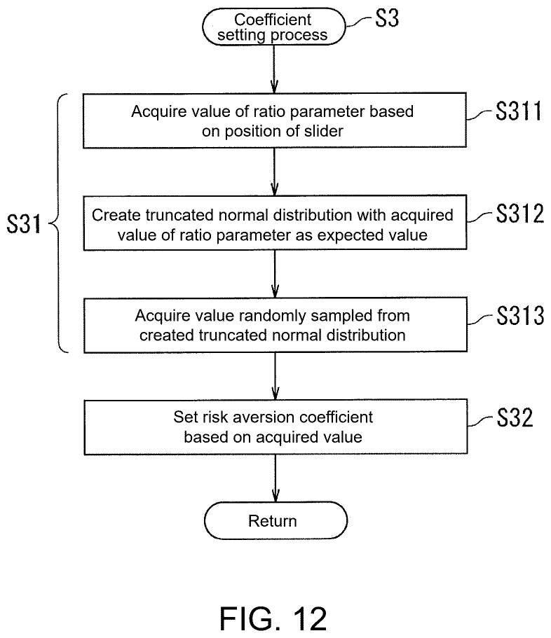

FIG. 12 is a flowchart showing an example of a coefficient setting process (Step S3 in FIG. 3) included in the support method of Embodiment 4. In other words, FIG. 12 shows an example of a flow of the process executed by the processing part 106 included in the terminal device 101A. As shown in FIG. 12, Step S31 in FIG. 11 may include Step S311 to Step S313.

Specifically, the processing part 106 acquires the value of the ratio parameter β based on the position of the slider 201 of the time the confirm button (not shown) is pressed, as described with reference to FIG. 5A to FIG. 5C (Step S311). In other words, the processing part 106 acquires the value on the first scale 202 at which the slider 201 is located.

Next, the processing part 106 creates a truncated normal distribution ND with the value of the ratio parameter β acquired based on the position of the slider 201 as the expected value (Step S312). For example, in the case where the acquired value of the ratio parameter β is 0.9, the processing part 106 creates the truncated normal distribution ND3 shown in FIG. 10C.

Next, the processing part 106 acquires a value randomly sampled from the created truncated normal distribution ND (Step S313). Then, the processing part 106 sets the value acquired by random sampling as the value of the ratio parameter β in Formula (4) above. As a result, the value of the risk aversion coefficient α is set based on Formula (4) above. For example, in the case where the truncated normal distribution ND3 shown in FIG. 10C is created, the processing part 106 sets the value acquired from the truncated normal distribution ND3 shown in FIG. 10C as the value of the ratio parameter β in Formula (4) above.

Embodiment 4 of the disclosure has been described above with reference to FIG. 9 to FIG. 12. According to Embodiment 4, similar to Embodiments 1 to 3, the operator can operate the slider 201 to more easily control the trade-off between the expected value and the variance of the response variable.

Further, in Bayesian optimization, there is a tendency for efficiency to improve if the behavior of the acquisition function differs for each exploration. According to Embodiment 4, the value of the risk aversion coefficient α can be set randomly. As a result, the behavior of the acquisition function becomes random for each exploration. Thus, there is a possibility of improving the efficiency of exploring the value of the explanatory variable that optimizes (maximizes or minimizes) the response variable.

In Embodiment 4, the terminal device 101A executes the support program SP as in Embodiment 1, but the server 300 may execute the support program SP as in Embodiment 2, or the control device 10 of the substrate processing system 1000 may execute the support program SP as in Embodiment 3.

The embodiments of the disclosure have been described above with reference to the drawings (FIG. 1 to FIG. 12). However, the disclosure is not limited to the above-described embodiments and may be implemented in various aspects within a range without deviating from the gist thereof. Further, multiple constituent elements disclosed in the above embodiments may be appropriately modified. For example, one constituent element among all constituent elements shown in one embodiment may be added to constituent elements of another embodiment, or some constituent elements among all constituent elements shown in one embodiment may be deleted from the embodiment.

To facilitate understanding of the disclosure, the drawings schematically show each constituent element as a main body. A thickness, a length, a number, an interval, etc. of each constituent element shown may differ from reality for convenience of drawing creation. Further, a configuration of each constituent element shown in the above embodiments is an example, is not particularly limited, and may be subjected to various changes within a range without substantially deviating from the effect of the disclosure.

For example, in the embodiments described with reference to FIG. 1 to FIG. 12, the support program SP includes the heteroscedasticity acquisition function AF, but the support program SP may include multiple types of acquisition functions. In that case, the support program SP may create a heteroscedasticity acquisition function AF based on an acquisition function set by the operator operating the operation part 102. Alternatively, the operator may operate the operation part 102 to set a formula of the heteroscedasticity acquisition function AF in the source code of the support program SP.

Further, in the embodiments described with reference to FIG. 1 to FIG. 12, the support program SP includes the preprocessing program FP, but it is also possible that the support program SP does not include the preprocessing program FP. For example, a program for preprocessing created by the operator may be stored in the storage parts 105 and 12.

The disclosure is useful for methods and systems that execute heteroscedasticity Bayesian optimization.

What is claimed is:

1. A support method supporting exploration of a value of an explanatory variable that maximizes or minimizes an expected value of a response variable, the support method comprising:
outputting, from a first machine learning model capable of outputting a predictive distribution, a first predictive distribution which is a predictive distribution of the expected value of the response variable;
outputting, from a second machine learning model capable of outputting a predictive distribution, a second predictive distribution which is a predictive distribution of a variance of the response variable;
performing a coefficient setting process of receiving setting of a value of a risk aversion coefficient included in a heteroscedasticity acquisition function; and
executing heteroscedasticity Bayesian optimization based on the first predictive distribution, the second predictive distribution, the heteroscedasticity acquisition function in which the value of the risk aversion coefficient is set in the coefficient setting process, and an exploration range, to acquire, from within the exploration range, a recommended value of the explanatory variable that maximizes the heteroscedasticity acquisition function, wherein
the heteroscedasticity acquisition function is a function in which the larger the value of the risk aversion coefficient becomes, the higher a proportion of acquiring the recommended value from a region with a smaller variance of the response variable becomes, and
the coefficient setting process comprises setting the value of the risk aversion coefficient based on a position of a slider operable by an operator.

2. The support method according to claim 1, wherein in setting the value of the risk aversion coefficient, a truncated normal distribution corresponding to the position of the slider is created, and the value of the risk aversion coefficient is set based on a value randomly sampled from the truncated normal distribution.

3. The support method according to claim 1, wherein the slider is movable between a first position at which a value on a first scale indicates a value greater than 0 and a second position at which the value on the first scale indicates a value less than 1, and
in setting the value of the risk aversion coefficient, the closer the position of the slider is to the second position, the larger a value the risk aversion coefficient is set to.

4. The support method according to claim 3, wherein in a case of supporting exploration of a value of the explanatory variable that minimizes the expected value of the response variable, the coefficient setting process comprises:
displaying the slider, the first scale, a first object indicating a virtual range corresponding to a range of possible values of the response variable, a second scale indicating a virtual expected value corresponding to the expected value, and a second object indicating one of values included in the second scale; and
configuring a length of the first object to be shorter and moving the second object to a position corresponding to a larger value among positions corresponding to the values included in the second scale, as the position of the slider is closer to the second position, and
in a case of supporting exploration of a value of the explanatory variable that maximizes the expected value of the response variable, the coefficient setting process comprises:
displaying the slider, the first scale, the first object, the second scale, and the second object; and
configuring the length of the first object to be shorter and moving the second object to a position corresponding to a smaller value among the positions corresponding to the values included in the second scale, as the position of the slider is closer to the second position.

5. A recording medium which is a computer-readable recording medium recording a support program specifying the support method according to claim 1.

6. A support system supporting exploration of a value of an explanatory variable that maximizes or minimizes an expected value of a response variable, the support system comprising:
a storage part storing a first machine learning model capable of outputting a predictive distribution, a second machine learning model capable of outputting a predictive distribution, and a heteroscedasticity acquisition function;
a display part displaying a slider;
an operation part receiving an operation on the slider by an operator; and
a processing part that outputs a first predictive distribution, which is a predictive distribution of the expected value of the response variable, from the first machine learning model, and outputs a second predictive distribution, which is a predictive distribution of a variance of the response variable, from the second machine learning model, wherein
the processing part is configured to:
set a value of a risk aversion coefficient included in the heteroscedasticity acquisition function based on a position of the slider, and
execute heteroscedasticity Bayesian optimization based on the first predictive distribution, the second predictive distribution, the heteroscedasticity acquisition function in which the value of the risk aversion coefficient is set based on the position of the slider, and an exploration range, to acquire, from within the exploration range, a recommended value of the explanatory variable that maximizes the heteroscedasticity acquisition function, and
the heteroscedasticity acquisition function is a function in which the larger the value of the risk aversion coefficient becomes, the higher a proportion of acquiring the recommended value from a region with a smaller variance of the response variable becomes.

7. The support system according to claim 6, wherein in setting the value of the risk aversion coefficient, the processing part creates a truncated normal distribution corresponding to the position of the slider, and sets the value of the risk aversion coefficient based on a value randomly sampled from the truncated normal distribution.

8. The support system according to claim 6, wherein the display part further displays a first scale,
in response to the operation on the operation part by the operator, the slider moves between a first position at which a value on the first scale indicates a value greater than 0 and a second position at which the value on the first scale indicates a value less than 1, and
in setting the value of the risk aversion coefficient, the processing part sets the risk aversion coefficient to a larger value as the position of the slider is closer to the second position.

9. The support system according to claim 8, wherein the display part further displays a first object indicating a virtual range corresponding to a range of possible values of the response variable, a second scale indicating a virtual expected value corresponding to the expected value, and a second object indicating one of values included in the second scale,
in a case of supporting exploration of a value of the explanatory variable that minimizes the expected value of the response variable, the processing part configures a length of the first object to be shorter and moves the second object to a position corresponding to a larger value among positions corresponding to the values included in the second scale, as the position of the slider is closer to the second position, and
in the case of supporting exploration of a value of the explanatory variable that maximizes the expected value of the response variable, the processing part configures the length of the first object to be shorter and moves the second object to a position corresponding to a smaller value among the positions corresponding to the values included in the second scale, as the position of the slider is closer to the second position.
